(19) United States
(12) Patent Application Publication
(10) Pub. No.: US 2016/0267108 A1
(43) Pub. Date: Sep. 15, 2016

(54) THERMAL IMAGE ARRANGING DEVICE AND METHOD, RECORDING DEVICE AND METHOD, AND ARRANGING SYSTEM

(71) Applicant: MISSION INFRARED ELECTRO OPTICS TECHNOLOGY CO., LTD, Hangzhou (CN)

(72) Inventor: Hao Wang, Hangzhou (CN)

(21) Appl. No.: 15/163,736

(22) Filed: May 25, 2016

Related U.S. Application Data
(63) Continuation of application No. PCT/CN2014/092223, filed on Nov. 25, 2014.

(30) Foreign Application Priority Data
Nov. 25, 2013 (CN) 201310607852.2

(51) Int. Cl. G06F 17/30; H04N 5/77; H04N 5/33

(52) U.S. Cl. CPC G06F 17/30268; H04N 5/33; H04N 5/77

(57) ABSTRACT

A thermal image arranging device and method, a recording device and method, and an arranging system relates to fields of infrared detection. In the prior art, the arranging workload of thermal imaging documents is great. A thermal image arranging device in this invention includes a selecting unit for selecting infrared data, an analyzing unit for analyzing object information associated with the selected infrared data, a comparing unit for matching object information based on the object data information stored in a storage medium, and a recording unit for recording the infrared data to which the object information matching the object data information corresponds and/or data acquired after specified processing for the infrared data with the object data information. A great number of thermal imaging documents can be arranged quickly, thus to improve the prior art.

### CROSS REFERENCE TO RELATED APPLICATIONS

The present application is a Continuation application of PCT application No. PCT/CN2014/092223 filed on Nov. 25, 2014, which claims the benefit of Chinese patent application No. 201310607852.2 filed on Nov. 25, 2013, all the contents of which are hereby incorporated by reference.

### BACKGROUND OF THE INVENTION

1. Field of the Invention

The invention relates to fields of infrared detection and, more particularly, to a thermal image arranging device and method, a recording device and method, and an arranging system.

2. Description of the Related Art

At present, a document name of a thermal image picture document acquired by a thermal image photographing device, is generated according to time or a serial number. One way of arranging the acquired thermal image picture documents is to produce a report of the thermal image picture documents, and object information related to photographed objects is manually inputted into the report and the report is stored in a folder. In another way, the document is stored to an infrared spectrum database of the thermal image picture document. A plurality of pieces of object data information related to the photographed objects are prestored in the database. When a user selects one piece of the object data information on a display interface, the user can select the thermal image picture document corresponding to the piece of the object data information and upload the thermal image picture document to the database.

In each industry, a thermal imager is widely and frequently used. For example, for the electric power industry, when a 220 KV substation is photographed, about 500 frames of the thermal imaging data may be generated. If the reports are manually produced and the thermal imaging data is manually uploaded, the workload is very great, and it is very easy to make mistakes.

Therefore, a thermal image arranging device capable of quickly arranging a great amount of the thermal imaging documents is needed, to solve the problems in the prior art.

BRIEF SUMMARY OF THE INVENTION

The invention provides a thermal image arranging device and method, a recording device and method, and an arranging system, to improve the prior art.

This invention provides a thermal image arranging device including

an acquiring unit for acquiring object information;

a comparing unit for matching the object information based on object data information stored in a storage medium;

a recording unit for recording a thermal imaging frame, corresponding to the object information matching the specified object data information, and/or data acquired after specified processing for the thermal imaging frame, with the object data information.

A recording device includes:

an acquiring unit for acquiring thermal imaging data;

an object information selecting unit for selecting object information from the object information stored in a storage medium;

a thermal image recording unit for recording a specified keyword in the object information selected by the object information selecting unit with the thermal imaging data acquired by the photographing unit and/or data acquired after specified processing for the thermal imaging data.

A thermal image processing system includes the recording device and the thermal image arranging device.

A thermal image arranging method includes:

an acquiring step for acquiring object information;

a comparing step for matching the object information based on object data information stored in a storage medium;

a recording step for recording a thermal imaging frame, corresponding to the object information matching the object data information, and/or data acquired after specified processing for the thermal imaging frame, with the object data information.

A recording method includes:

an acquiring step for acquiring thermal imaging data;

an object information selecting step for selecting object information from the object information stored in a storage medium;

a thermal image recording step for recording a specified keyword in the object information selected in the object information selecting step with the thermal imaging data acquired in the acquiring step and/or data acquired after specified processing for the thermal imaging data.

These and other aspects and advantages of the present invention will be described with regard to the following description.

### BRIEF DESCRIPTION OF THE DRAWINGS

FIG. 1 is a block diagram showing a thermal imaging device according to a first embodiment;

FIG. 2 is an outline diagram showing the thermal imaging device according to the first embodiment;

FIG. 3 is a schematic diagram showing a table of object data information stored in a storage medium;

FIG. 4 is a flow chart of the first embodiment;

FIG. 5 is a flow chart of the first embodiment;

FIG. 6 is a block diagram showing a recording device in a second embodiment;

FIG. 7 is an outline diagram showing the recording device in the second embodiment;

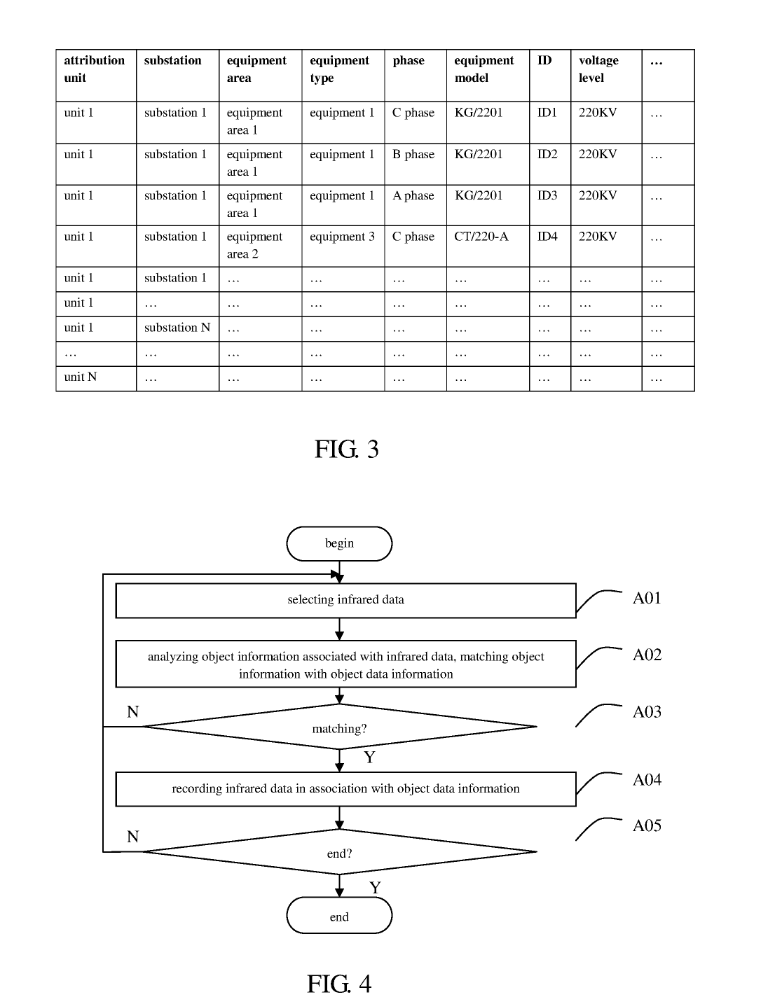

FIG. 3 is a schematic diagram showing a table of object information stored in a storage medium;

FIG. 9 is a schematic diagram showing a display interface for selecting and photographing the object information;

FIG. 10 is a flow chart of the second embodiment.

### DETAILED DESCRIPTION OF THE INVENTION

For better understanding, the following described embodiments do not limit the scope of the invention and can be changed to different forms in the scope of the invention.

The embodiments of the invention are described. In a first embodiment, a thermal image arranging device 1 for processing thermal imaging documents, for example a processing device such as a personal computer or a personal digital processing device, is taken for example, and a thermal image photographing device with a photographing function may also be used for arranging a plurality of thermal image picture documents or thermal image dynamic documents.

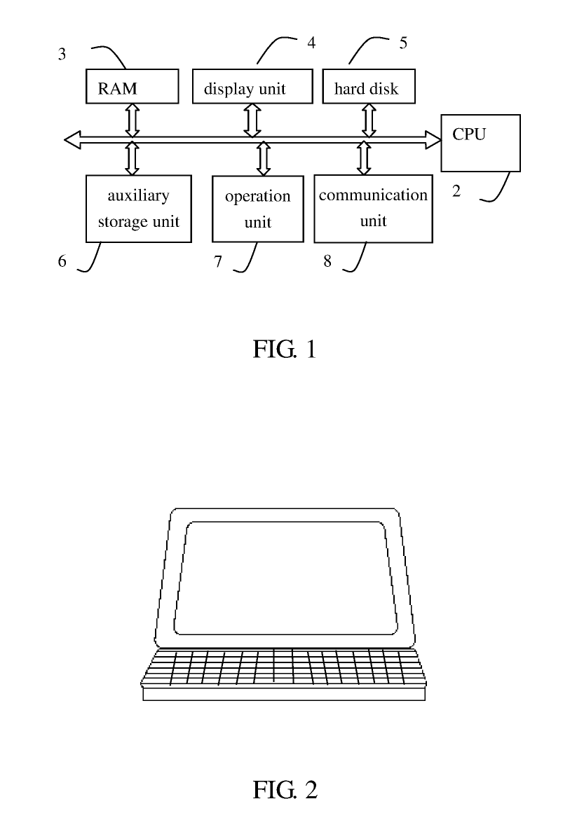

In the first embodiment, FIG. 1 is a block diagram showing the thermal image arranging device 1.

In the embodiment, the thermal image arranging device 1 includes a CPU 2 for performing the overall control, a RAM 3, a display unit 4, a hard disk 5, an auxiliary storage unit 6, an operation unit 7, and a communication unit 8, connected with the CPU 2 via a bus.

According to an outline diagram of the thermal image arranging device 1 in FIG. 2, the thermal image arranging device 1 may be a computer, a PDA, a special-used display processing device, or a special-used thermal image arranging device 1.

The RAM 3 is used for temporarily storing different data generated by the CPU 2.

The display unit 4 such as a liquid crystal display may perform display under the control of the CPU 2. However, the invention is not limited thereto. The display unit 4 may be other display connected with the thermal image arranging device 1, and the thermal image arranging device 1 may not include the display in itself.

The hard disk 5 stores control programs and different kinds of data used in different control.

The auxiliary storage unit 6 may be a storage medium such as a CD-ROM or a storage card and a related interface thereof.

The operation unit 7 is used for a user to give instruction to the thermal image arranging device 1 or to input setting information. The CPU 2 executes the corresponding programs according to the operation signals of the operation unit 7. The operation unit 7 may include a keyboard, a mouse, a touch screen, or a phonic control component.

The communication unit 8 may be a communication device for connecting the thermal image arranging device 1 and an external device according to communication specification such as USB, 1394, or network.

The CPU 2 controls the all action of the thermal image arranging device 1, and the control programs stored in the hard disk 5 allows the CPU 2 to perform the corresponding processing.

The CPU 2 as an acquiring unit is used for acquiring object information. The object information may be the object information associated with a thermal imaging frame. The mode of the thermal imaging frame may be a thermal image picture document (each document includes a thermal imaging frame), a thermal image dynamic document (each document includes a plurality of thermal imaging frames, such as a thermal image video document, a thermal imaging dataflow document, etc.), or the thermal imaging frame in other ways. The thermal imaging frame may include AD value data of a thermal image, image data of an infrared thermal image, array data of temperature values related to a thermal image, or the compressed data of the above data.

In one embodiment, the object information corresponding to the thermal imaging frame is acquired according to the information related to the thermal imaging frame, while the thermal imaging frame is not necessary to be selected. For example, several thermal image picture documents and an information index document related to the thermal image picture documents may be stored in a storage card, the object information in the information index document and a document name of the thermal image picture document corresponding to the object information may be acquired by analyzing the information index document, thus to acquire the object information corresponding to each of the thermal image picture documents, respectively. In another embodiment, a thermal image dynamic document and an information index document related to the thermal image dynamic document may be stored in a storage card, by analyzing the information index document, the object information in the information index document may be acquired, and a frame time sequence or a storage address, such as a frame number, of the thermal imaging frame corresponding to the object information in the thermal image dynamic document may be acquired, thus to acquire the thermal imaging frame corresponding to the object information in the thermal image dynamic document. The information index document may include one or more pieces of the object information corresponding to one or more thermal imaging frames. The information related to the thermal imaging frame is not limited to be stored in the same storage medium with the thermal imaging frame, and preferably, the information related to the thermal imaging frame may include information of a storage medium and a storage address of the corresponding thermal imaging frame.

In another embodiment, the object information associated with the thermal imaging frame is acquired by analyzing the selected thermal imaging frame. For example, the object information that is attached to the thermal image picture document may be acquired from the selected thermal image picture document.

The CPU 2 as a selecting unit is used for selecting a thermal imaging frame. For example, the CPU 2 may select a thermal image picture document and/or a thermal image dynamic document from a storage medium such as the auxiliary storage unit 6 or the hard disk 5, or may select a thermal imaging frame from an external device wiredly or wirelessly connected via the communication unit 8. For example, a thermal image picture document may be selected from an external storage device or a thermal image photographing device connected with the thermal image arranging device 1. The selecting unit may select one or more thermal image picture documents, and/or one or more thermal image dynamic documents. Preferably, the selecting unit may select a plurality of thermal imaging frames of different document modes.

When a plurality of thermal imaging frames are selected, such as a plurality of thermal image picture documents are selected, in one embodiment, the selected thermal image picture documents may be analyzed, compared, and recorded in turns. In another embodiment, the CPU 2 includes a plurality of processors for analyzing, comparing, and recording the specified amount of the selected thermal image picture documents at the same time.

The CPU 2 as an analyzing unit is used for analyzing the object information associated with the thermal imaging frame. Preferably, a specified keyword in the object information associated with the selected thermal imaging frame may be analyzed. The specified keyword may be predetermined, to improve a processing speed. Further, the keyword may include an ID number corresponding to a photographed object.

The object information may be identity information related to a photographed object, such as the information representing the self-property of the photographed object, i.e. an address, a type, or a number. In one example, the object (electric power equipment) information may include the information representing a place (such as a substation, an equipment area), an equipment type (the type may be a transformer or a switch; or further including a voltage level, a model, a manufacturer, or a manufacturing batch), and a phase (such as A phase, B phase, C phase), of the photographed object. In this embodiment, the object information includes the information representing the address, type (for example, the type of the electric power equipment includes a transformer and a switch), and a phase, of the photographed object, preferably including ID information corresponding to the photographed object. In another example, the object information may further include an attribution unit, a model, a voltage level, an importance grade, a manufacturer, performance and characteristics, a passed photographing or repairing record, a manufacturing date, a service life, or part information, related to the photographed object. There are pluralities of embodiments for associating the object information with the thermal imaging frame. Preferably, the association may be performed during photographing, or may be performed during arrangement after photographing.

The CPU 2 as a comparing unit is used for comparing the object data information related to the photographed object stored in a storage unit (a storage medium) of the object data information with the acquired object information. For example, the comparison based on the attribute similarity may be performed. In one embodiment, the object information “substation 1 equipment area 1 equipment 1 phase B” is taken for example. When the object data information includes the information of the object information “substation 1 equipment area 1 equipment 1 phase B”, the object data information matches the object information. In another embodiment, a specified keyword in the object data information and a specified keyword in the object information are compared. For example, when an attribute of a specified keyword includes “substation, equipment area, equipment type, phase, part”, the keyword of the attribute may be extracted from the object information, and is compared with the keyword of the attribute in the object data information. When the keywords are the same, the object data information matches the object information.

Preferably, the tolerance of the object data information may be considered in the composition of the object data information. For example, the matched object information corresponding to the same photographed object may include the information with the same meaning and different characters. A current transformer of electric power type is taken for example, the information “current transformer”, “evolution” and “CT” represents the same meaning. The different character information with the same meaning of the equipment type may be prepared in advance, to adapt for the tolerance of the similarity of the matching.

In another example, the matching of several keywords may be performed, to improve the accuracy of the matching. Preferably, the keyword for matching may include an ID number, to improve the accuracy of the matching. Since the infrared photographing application is special, a photographed object may have several photographing parts. Therefore, the keyword for matching includes “part information”, and correspondingly, the object data information may include the common part information of the photographed object.

In another example, an algorithm for matching includes the comparison of the attribute similarity of the object information, and further other conditions related to the thermal imaging frame such as an analysis result, a photographing parameter (such as a radiation rate, a photographing distance, an environment temperature during photographing, a wind speed, or humidity) may be considered. For example, when the analysis result is considered, during matching, if the analysis data corresponding to the thermal imaging data is located in a specified analysis data range may further be determined, as one condition for determining match or not.

The object data information related to the photographed object is stored in a storage medium such as the hard disk 5, and may be stored via different data documents. Preferably, the object data information related to the photographed object may be stored in a database. The database or data documents of the object data information may be stored in the storage medium.

The storage medium may be a storage medium in the thermal image arranging device 1, such as a non-volatile storage medium i.e. the hard disk 5, or a volatile storage medium i.e. the RAM 3, or may be other storage mediums wiredly or wirelessly connected with the thermal image arranging device 1, such as a storage medium in other devices that is wiredly or wirelessly connected with the communication unit 8, i.e. another storage device, a thermal imaging device, or a computer, or a storage medium of a network destination.

The object information is the information related to the photographed object, such as the information representing the self-property of the photographed object, i.e. an address, an equipment type, or a number. Referring to a table in FIG. 3, one example of the stored object data information is described. In FIG. 3, there are multiple pieces of the object data information, each piece of the object data information includes the information related to the photographing object, including the information “attribution unit, photographed object address, “substation, equipment area”, equipment type, phase“, and may further include an equipment type, an ID number, a voltage level, an importance grade, a manufacturer, performance and characteristics, a passed photographing or repairing record, a manufacturing date, a service life, etc. Preferably, according to the specified application of the infrared thermal image, the information such as constituted data of a reference image, information of an analysis area, an analysis mode, a diagnosis rule, or part information, corresponding to a photographed object may be further included. The object data information may be different according to different applications.

The constituted data of the reference image is used for acquiring a reference image reflecting specified morphological characters of a photographed object. The reference image may be overlapped on an infrared thermal image when the thermal imaging frame associated with the object data information is analyzed, to match a thermal image of the photographed object in the infrared thermal image by adjusting the reference image according to an analysis area associated with the reference image, thus to configure the standard analysis area.

The information of the analysis area is used for acquiring the information related to the preferred analysis area that is used for analyzing the thermal image corresponding to the photographed object, such as the constituted data of the analysis area and the position parameter of the analysis area.

The analysis mode represents an analysis rule that is used to analyze the thermal imaging frame thus to acquire an analysis result, such as an analysis calculating rule that is used to analyze the thermal imaging frame determined by the analysis area to acquire an analysis result. For example, in the temperature analysis, the analysis mode may be to calculate a maximum temperature, an average temperature, a minimum temperature, percentage content, or calculation relation between the analysis areas, such as a temperature difference. The analysis mode can include a diagnosis rule. During analysis, the analysis data is compared with a specified judging value according to a specified comparing relation, to acquire a diagnosis result.

The part information may include component information, photographing part information, and angle information, corresponding to a photographed object. In one embodiment, the part information may be the component information of a photographed object, such as a connector, a brushing, or a base. In another embodiment, the part information may be the photographing part information of a photographed object, such as an upper portion, a middle portion, or a lower portion. Further, the part information may be a combination of the component information and the photographing part information or angle information, such as an upper portion of a bushing, a lower portion of a bushing. Further, the part information may be a subdivision of component types, such as a connector may be divided into a T-connector, a splicing sleeve, and a parallel groove clamp. The different part information may be prepared in advance according to the parts of the photographed object to be photographed and analyzed.

The CPU 2 as a recording unit is used for recording the thermal imaging frame, to which the object information matching the object data information corresponds, and/or the data acquired after specified processing for the thermal imaging frame with the piece of the object data information. For example, the thermal imaging frame (the object information corresponding to the thermal imaging frame matches the object data information) matching the object data information may be recorded with the object data information, and preferably may be stored on a specified storage area (an example of a first storage unit) in the hard disk 5. In another embodiment, the specified processing is performed for the thermal imaging frame, and the analysis result acquired by analysis may be recorded with the object data information. In another embodiment, the specified processing is performed for the thermal imaging frame, such as decompress to acquire the thermal image AD data, and the thermal image AD data may be recorded with the object data information.

Preferably, the CPU 2 as the recording unit is used for recording the thermal imaging frames that are not matched with the object data information stored in the storage unit of the object data information, on another specified storage area (an example of a second storage unit) of the hard disk 5. Thus, it is convenient for a user to rearrange the object information associated with the thermal imaging frame. Preferably, the unmatched thermal imaging frames are stored to a specified folder.

The first storage unit and the second storage unit may be different storage mediums. For example, the first storage unit is the hard disk 5, while the second storage unit is a storage medium of the auxiliary storage unit such as a storage card.

Further, the CPU 2 as an analyzing unit is used for analyzing the matched thermal imaging frame. The object information associated with the thermal imaging frame matches the object data information. Preferably, according to the object data information matching the object information and the analysis mode associated with the object data information, the thermal imaging frame is analyzed. Further, the recording unit is used for recording the thermal imaging frame that is matched with the corresponding object data information and the analysis result of the thermal imaging frame with the object data information.

The CPU 2 as a thermal image display controlling unit is used for displaying an infrared thermal image acquired according to the thermal imaging frame associated with the selected object data information.

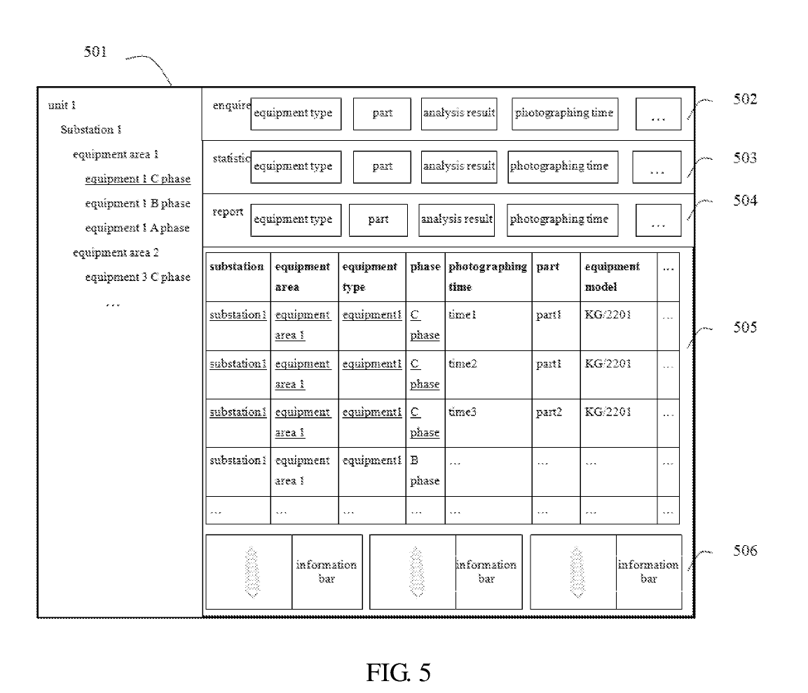

Referring to FIG. 5, the display interface includes an object data information display area (an area 501), an enquiring option operating area (an area 502), a statistics option operating area (an area 503), a report option operating area (an area 504), an object data information recording display area (an area 505), a display area (a display area 506) of an information bar such as an infrared thermal image and analyzed data and a photographing parameter.

The CPU 2 as an object data information display controlling unit is used for displaying the specified amount of the object data information. The specified amount may be acquired based on the database of the object data information, shown in the display area 501 in FIG. 5. When the same object data information is associated with a plurality of thermal imaging frames, the information such as the part information or the photographing time corresponding to the thermal imaging frames may be displayed, or the record of the object data information corresponding to the thermal imaging frames and the information such as the part information and photographing time of the thermal imaging frame may be displayed in the display area 505. A user may further select the information corresponding to the thermal imaging frame from the display area 505. In another embodiment, the object data information display controlling unit may display the specified amount of the object data information satisfying a specified enquiring condition.

The CPU 2 as a thermal image display controlling unit may display the infrared thermal image acquired according to the thermal imaging frame associated with the selected object data information and/or the information related to the thermal imaging frame such as the analysis result and photographing parameter, on the display area 506. The selected object data information may be defaulted, or may be selected from the object data information in the display area 501 by a user.

Further, the CPU 2 as the thermal image display controlling unit is used for displaying the infrared thermal image, acquired according to the thermal imaging frame associated with the selected object data information, and the infrared thermal image acquired according to the specified amount of the related thermal imaging frames based on a specified relation. The specified relation may be time, the phase, the same type, and the part information.

For example, based on the object data information with the same specified keyword “substation 1 equipment area 1 equipment 1 C phase”, the previously photographed infrared thermal images are displayed according to time. Based on the object data information with the same specified keyword “substation 1 equipment area 1 equipment 1”, the infrared thermal images of the three phases in the same group are displayed according to the phase. Based on the object data information with the same specified keyword “substation 1 equipment area 1 equipment 1 C phase”, the infrared thermal images of each part (such as a connector, a bushing) are displayed according to the part information. The three infrared thermal images in the display area 506 represent the infrared thermal images of the photographed object “substation 1 equipment area 1 equipment 1 C phase” at different time or with different part information, respectively.

The displayed infrared thermal images are usually used for the transverse comparative analysis of the thermal imaging frames of the photographed objects of the same type, the historical comparison of the thermal imaging frames of the same object, the comparative analysis of the thermal imaging frames of the objects in the same group (for example, the condition of the same group is A phase, B phase, and C phase, or the condition of the same group is in the same equipment area), and the comparative analysis of the parts of the thermal imaging frames.

The CPU 2 as an enquiring unit, a statistical unit, a reporting unit, a comparison analyzing unit, may realize the corresponding enquiring, statistical, reporting, comparing, and analyzing function, according to a specified condition, such as “equipment type”, “part information”, “analysis result”, “photographing time”, “object data information”, or a combination thereof, such as the enquiring option operating area (the area 502), the statistical option operating area (the area 503), and the reporting option operating area (the are 504) shown in FIG. 5.

Referring to FIG. 4, the control flows of the embodiment are described.

When the thermal image analyzing device 1 is powered, the CPU 2 performs the control and controls to display the corresponding processing interface. A user may select a thermal image picture document stored in the auxiliary storage unit 6 or the hard disk 5, to determine the thermal imaging frame to be processed, and the infrared thermal image acquired by the thermal imaging frame may not be displayed. In addition, the thermal imaging frame may be selected from an external device connected with the communication unit 8. For example, the thermal imaging frame to be processed is acquired from an external storage device or a thermal image photographing device. In one embodiment, the processing interface may not be displayed, and the specified amount of the thermal imaging frames may be automatically selected from the storage medium. For example, the thermal image picture documents in the storage card of the auxiliary storage unit may be automatically selected.

In step A01, a thermal imaging frame to be processed is selected.

A user may select one or more thermal image picture documents, or may select a folder including the above document. In addition, the specified amount of the thermal image picture documents in the specified storage medium may be automatically selected.

In the embodiment, when a plurality of the thermal image picture documents are selected, the selected thermal image picture documents may be analyzed, compared, and recorded in turns. The CPU 2 selects one of the thermal image picture documents as the thermal imaging frame to be processed.

In step A02, the object information associated with the selected thermal imaging frame is analyzed, and is matched with the object data information in the database, such as according to the specified keyword. The object information attached to the thermal image picture document may be acquired by analysis, or the object information in the information index document associated with the thermal image picture document may be acquired.

The associating mode of the object information and the thermal imaging frame may be that the object information is attached to the thermal imaging frame, such as attached to the thermal image picture document (attached to the document name). At that moment, the object information may be acquired from the thermal image picture document. Otherwise, the object information may be attached to the information index document associated with the thermal image picture document, and the object information may be acquired from the information index document.

In step A03, if the object data information matches the object information is determined. If the object data information matching the object information is not found, the step A01 is returned, and a new thermal image picture document is reselected from the selected thermal image picture documents. Preferably, the unmatched thermal image picture document (without the association with the object information, or the associated object information is not matched with the object data information) is recorded on the specified area of the hard disk 5, such as a specified folder, to facilitate a user to examine if there is a problem of the object data information or the object information. If the matching is determined, the next step is entered.

In step A04, the thermal imaging frame is recorded with the piece of the object data information. For example, the thermal image picture document is stored to the specified area of the hard disk 5, and the document name or the index information of the thermal image document is associated with the piece of the object data information, such as generating one record of the database or generating the data with the specified structure in the data document.

In step A05, if the selected thermal image picture documents are all processed is determined. If not finished all, return to the step A01, the next thermal image picture document is selected, and the subsequent steps are repeated.

According to the above, the object information associated with the thermal imaging frame is analyzed and is matched with the object data information, and the matched thermal imaging frame is recorded with the object data information, thereby improving the processing speed and greatly reducing the manual workload. It is convenient for uploading a large amount of thermal imaging frames to an infrared spectrum database, to achieve the automatic batch arrangement.

The arrangement of the thermal image dynamic document may be performed according to the object information associated with the thermal imaging frame in the thermal image dynamic document, referring to the above steps. When parts of the thermal imaging frames are associated with the object information, the object information associated with the parts of the thermal imaging frames may be analyzed, respectively, and may be matched with the object data information, and the matched thermal imaging frames are recorded with the object data information. For example, the thermal imaging frame may be extracted from the thermal image dynamic document and may be recorded with the object data information, the storage address of the thermal image dynamic document, the document name of the thermal image dynamic document, and the frame sequence of the matched thermal imaging frame (such as the frame number in the thermal image dynamic document) may be recorded with the object data information, or the document name of the thermal image dynamic document (such as all frames of the thermal image dynamic document are associated with the same object information) may be recorded with the object data information. In one embodiment, the processing may be performed in turns, such as according to the frame sequence. In another embodiment, the thermal image dynamic document is associated with an information index document, and the information index document includes the object information associated with the thermal imaging frame and the frame sequence information of the thermal imaging frame in the thermal image dynamic document. The object information associated with the thermal imaging frame may be acquired via the information index document, and the following matching and recording may be performed.

In another embodiment, the information index document is stored in a storage medium, and the information index document is read by selection of a user or automatically from the storage medium. The information index document includes the index information of the thermal imaging frame and the object information corresponding to the thermal imaging frame. The object information may not be acquired via the selection of the thermal imaging frame, while the object information corresponding to the thermal imaging frame may be acquired by the analysis of the information index document. The acquired object information is matched with the object data information in the storage unit (a storage medium) of the object data information, and the thermal imaging frame corresponding to the matched object information is recorded with the object data information matching the object information.

Further, the information related to the thermal imaging frame such as the information index document is not limited to be stored with the thermal imaging frame in the same storage medium. For example, the information index document may be acquired via the connection of the communication unit 8 and an external device, such as the connection with an external storage device or a thermal image photographing device. The thermal imaging frame may be stored to a storage medium externally configured. When the matching of the object information in the information index document and the object data information stored in the storage unit of the object data information is finished, the thermal image arranging device acquires the thermal imaging frame corresponding to the matched object information from a storage medium of an external device, and records the thermal imaging frame with the object data information matching the object information.

Further, the CPU 2 as an analyzing unit is used for analyzing the matched thermal imaging frame. The object information associated with the thermal imaging frame matches the object data information. Preferably, according to the object data information matching the object information and the analysis mode associated with the object data information, the thermal imaging frame is analyzed. Further, the recording unit is used for recording the thermal imaging frame that is matched with the corresponding object data information and the analysis result of the thermal imaging frame with the object data information, thus to facilitate the subsequent browsing, enquiring, statistics, and report of the infrared thermal image.

This embodiment may be applied to a portable thermal image photographing device or different online thermal image photographing devices. The modification and changes for the embodiment in the scope of the invention ma be performed, and the modification in the scope of the claims is as one part of the invention. In one word, the first embodiment is one preferred embodiment. Any product executing this embodiment of this invention may not achieve all of the above advantages at the same time.

### Embodiment Two

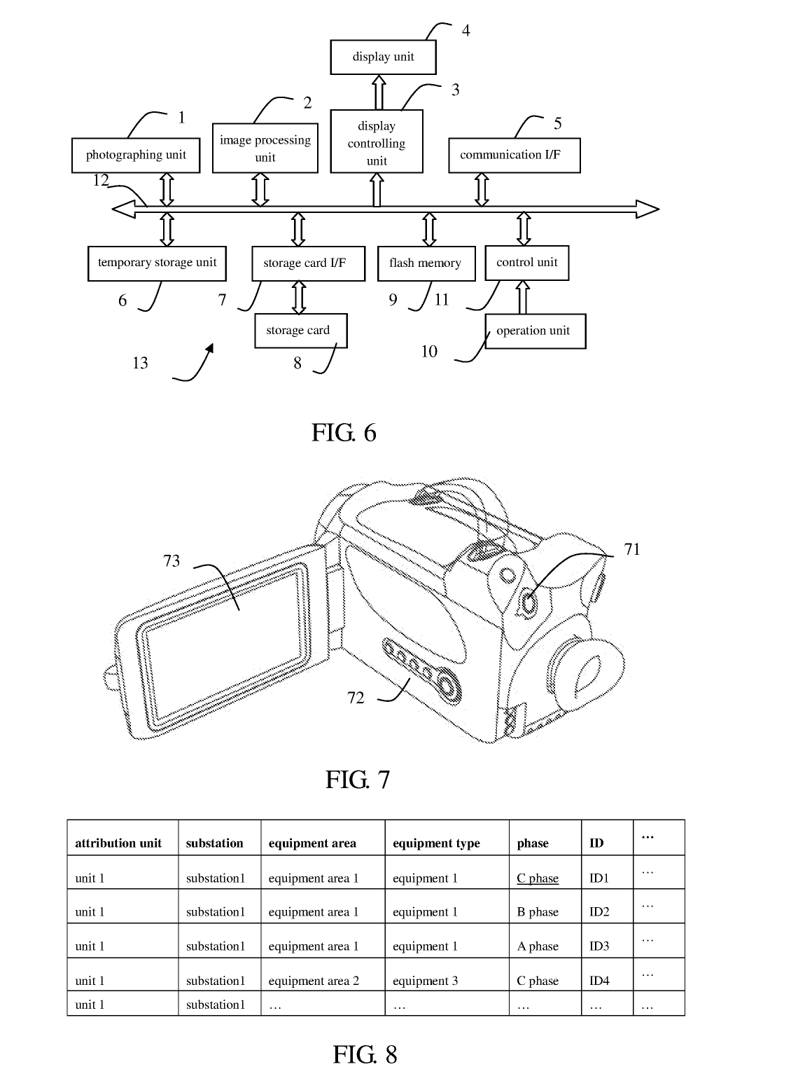

In the second embodiment, a portable thermal imaging device 13 with a photographing function is as an example of a recording device. Referring to FIG. 6, the structure of the thermal imaging device 13 in the second embodiment is described.

The thermal imaging device 13 includes a photographing unit 1, an image processing unit 2, a display controlling unit 3, a display unit 4, a communication I/F 5, a temporary storage unit 6, a storage card I/F 7, a storage card 8, a flash memory 9, an operation unit 10, and a control unit 11. The control unit 11 is connected with each other unit via a control and data bus 12, and is responsible for the overall control of the thermal imaging device 13.

The photographing unit 1 includes an optical unit, a lens driving unit, an infrared detector, and a signal preprocessing circuit, which are not shown. The optical unit is composed of infrared optical lenses, and is used for focusing received infrared radiation on the infrared detector. The lens driving unit drives the lenses to perform focusing or zooming operation according to a control signal of the control unit 11, and the optical unit may also be manually regulated. The infrared detector, such as a refrigerating or non-refrigerated infrared focal plane detector, converts the infrared radiation passing through the optical unit to electrical signals. The signal preprocessing circuit, including a sample circuit, an AD conversion circuit, and a timing trigger circuit, performs signal processing such as sampling for the electric signals output from the infrared detector in a specified period. The signals are converted to digital thermal imaging data by the AD conversion circuit. The thermal imaging data may be 14-bit or 16-bit binary data (also called thermal imaging AD value data). In the first embodiment, the photographing unit 1 is as an acquiring unit for acquiring the thermal imaging data.

The image processing unit 2 is used for performing specified processing for the thermal imaging data acquired by the photographing unit 1. The image processing unit 2 performs processing for converting data to be suitable for displaying or recording, such as modification, interpolation, pseudo-color, synthesis, compression, or decompression. For example, the image processing unit 2 may perform specified processing, such as pseudo-color processing, for the thermal imaging data acquired by the photographing unit 1, to acquire image data of infrared thermal images. The image processing unit 2 may be realized by a DSP, other microprocessors, or a programmable FPGA.

According to the control of the control unit 11, the display controlling unit 3 generates and outputs video signals generated according to the image data for displaying stored in the temporary storage unit 6, and the video signal can be displayed on the display unit 4. The display unit 4 may be a liquid crystal display with an aspect ratio of 4:3. Preferably, to clearly display the infrared thermal image and object information, a liquid crystal display with an aspect ratio of 16:9 may be adopted.

The communication I/F 5 may be an interface for connecting and exchanging data between the thermal imaging device 13 and an external device according to communication specification such as USB, 1394, or network. The external device may be a personal computer, a server, a PDA (personal digital assistant device), other thermal imaging devices, or a visible-light photographing device.

The temporary storage unit 6, such as a RAM or DRAM volatile storage, is a buffer storage for temporarily storing the thermal imaging data output from the photographing unit 1, and is a working storage of the image processing unit 2 and the control unit 11 for temporarily storing the processed data of the image processing unit 2 and the control unit 11.

The storage card I/F 7 is used as an interface of the storage card 8. The storage card I/F 7 is connected with the storage card 8 that is as a rewritable non-volatile storage, which can be detachably installed in a groove of the main body of the thermal imaging device 13 and can record the data such as the thermal imaging data according to the control of the control unit 11.

The flash memory 9 stores control programs and different kinds of data used in different control.

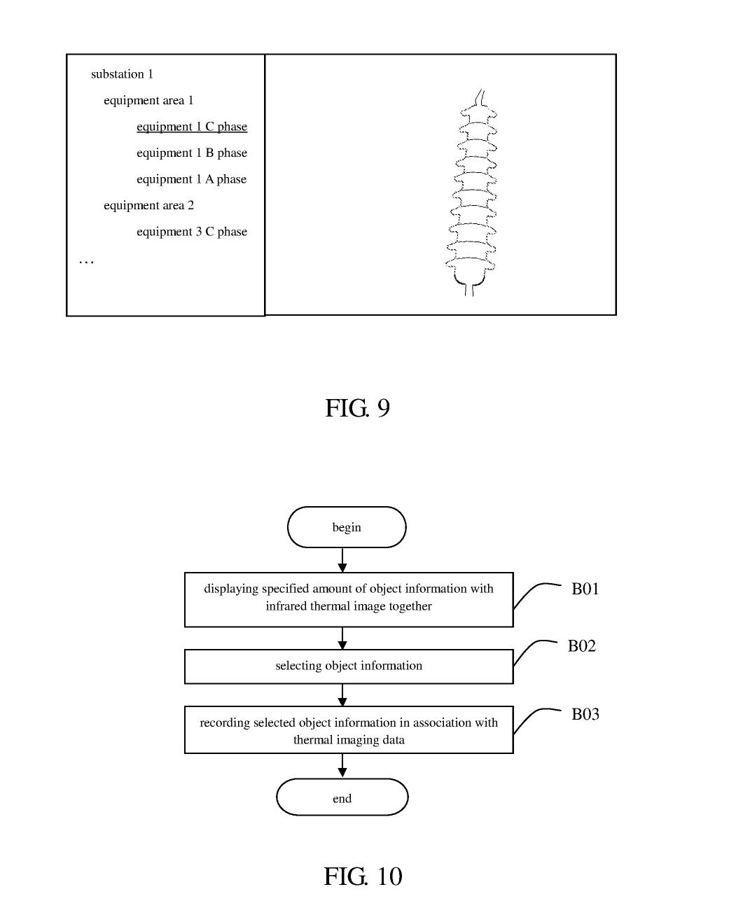

The operation unit 10 is used for a user to perform different operation. The control unit 11 executes the corresponding program according to an operation signal of the operation unit 10. Referring to FIG. 7, the operation unit 10 may include a record key 71 and an analysis key 72. However, the invention is not limited thereto. A touch screen 73 or a phonic unit (not shown) may be used for realizing related operation.

The control unit 11 controls the whole action of the thermal imaging device 13, and the storage medium such as the flash memory 9 stores the control programs and different data used in different control. A CPU, a MPU, a SOC, and programmable FPGA may realize the control unit 11. The image processing unit 2 and the display controlling unit 3 may be a processor integrally formed with the control unit 11.

The control unit 11 as an object information selecting unit is used for selecting object information. Preferably, the control unit 11 controls to allow the specified amount of the object information and the infrared thermal image to be displayed together, providing for a user to select.

The object information may be identity information related to a photographed object, such as the information representing the self-property of the photographed object, i.e. an address, a type, or a number. To facilitate distinguishing, the object (electric power equipment) information may include the information representing a place (such as a substation, an equipment area), an equipment type (the type of the electric power equipment may include a transformer and a switch), and a phase, of the photographed object, preferably including ID information corresponding to the photographed object. In another example, the object information may further include an attribution unit, a model, a voltage level, an importance grade, a manufacturer, performance and characteristics, a passed photographing or repairing record, a manufacturing date, a service life, or part information, related to the photographed object. FIG. 8 shows an example of a table of the object information stored in a storage medium.

The storage medium may be a storage medium in the thermal imaging device 13, such as a non-volatile storage medium i.e. the flash memory 9 and the storage card 8, or a volatile storage medium i.e. the temporary storage unit 6, or may be other storage mediums wiredly or wirelessly connected with the thermal imaging device 13, such as a storage medium in other devices that is wiredly or wirelessly connected with the communication I/F 5, i.e. another storage device, a thermal imaging device, or a thermal image arranging device, or a storage medium of a network destination.

The detailed operation and control flows of the second embodiment are described hereinbelow. The scene may be to photograph a photographed object in a substation. When the power is on, the interior circuit of the control unit 11 is initialized, and then a photographing mode is entered. That is, the photographing unit 1 acquires the thermal imaging data, the image processing unit 2 performs specified processing for the thermal imaging data acquired by the photographing unit 1, the processed data is stored to the temporary storage unit 6, and the control unit 11 controls the display controlling unit 3, to allow the display unit 4 to dynamically display the infrared thermal image in a dynamic image mode and the selecting bar of the object information, such as the display interface in FIG. 9. The control steps are described according to FIG. 10.

In step B01, in the photographing mode, the display unit 4 displays the dynamic infrared thermal image, and displays the specified amount of the object information according to the object information stored in the storage medium. A user can turn a page to see the object information (such as by adjusting a scroll bar). The displayed object information identifier may usually only include information of a place, a type, and a phase of the photographed object, while it is not necessary to display all information of the object information.

Preferably, a widescreen (such as a widescreen of 16:9) may be adopted. Therefore, the indicating information such as the object information may be displayed with the infrared thermal image together, without overlapping the infrared thermal image (usually 4:3). In addition, the object information may be superimposed on the infrared thermal image.

In step B02, the object information is selected. When a user selects “substation 1 equipment area 1 equipment 1 C phase”, the corresponding photographed object may be photographed, and “equipment 1 C phase” in the displayed object information is shown in a way different from other object information, for example, an underline is shown. When there is the information of several attributes, the object information may be selected by the multiple selections for the information of the several attributes.

According to the feature of infrared detection, the photographed object may be photographed from multiple angles. In one preferred mode, the different part information may be prepared according to the parts of the photographed object to be photographed and analyzed. Further, according to the selected object information and the associated part information, the selecting bar of the part information may be displayed on the display interface automatically or based on an instruction of a user, for displaying the part information of the selected object information, such as the part “connector”, “upper portion of bushing”, “lower portion of bushing” included by the photographed object “substation 1 equipment area 1 equipment 1 C phase”. A user can select the corresponding part information such as “connector”, and then the subsequent recording processing is performed.

In step B03, when there is a record instruction, the specified thermal imaging data is recorded with the information of the specified keyword related to the selected object information “substation 1 equipment area 1 equipment 1 C phase”.

The specified thermal imaging data may be the thermal imaging data (frame) acquired according to the signals read by an infrared detector at the moment of responding to the record instruction, may be the specified thermal imaging data (frame) in the multi-frame thermal imaging data stored in the temporary storage unit 6 at the moment of responding to the record instruction, may be the data acquired after specified processing for the thermal imaging data in the above conditions (the specified processing may be modification, interpolation, pseudo-color, temperature value conversion, pixel reduction, compression, or a combination thereof), may be a specified amount of multi-frame thermal imaging data that is recorded, may be the thermal imaging data (frame) acquired after specified processing for the specified amount of the multi-frame thermal imaging data, such as one frame of the thermal imaging data acquired after integral calculation for the multi-frame thermal imaging data stored in the temporary storage unit 6, or may be one or more infrared thermal image acquired according to the above conditions, such as the temperature value of each pixel acquired at the time of recording the thermal imaging data and the image data of the infrared thermal image.

In detail, in one embodiment, in response to the record instruction of the operation unit 10, the control 11 controls the infrared detector to read signals, to acquire the thermal imaging data and to allow the image processing unit 2 to perform specified compression for the thermal imaging data or perform specified processing such as modification, interpolation before compression for the thermal imaging data, the information related to the selected object information in the temporary storage unit 6 is associated with the compressed thermal imaging data thus to generate the thermal image picture document that is recorded on the storage card 8, and the processing is end. In addition, the compression may be performed after the information is attached.

In another embodiment, a thermal image recording unit continuously records the acquired thermal imaging data to generate a thermal image dynamic document. When there is a record instruction associated with the object information, the control unit 11 controls an infrared detector to read signals to acquire the thermal imaging data, and allows the information related to the selected object information in the temporary storage unit 6 to be associated with the compressed thermal imaging data and to be stored in the thermal image dynamic document. The frame sequence of the thermal imaging data may be associated with the information of the specified keyword related to the selected object information and recorded on an index area of the thermal image dynamic document, and the following dynamic record is performed.

The information related to the selected object information may be all information or one part of the object information of the selected object information, while at least including the specified keyword. The specified keyword is used for matching with the object data information. In one embodiment, the specified keyword may be “substation 1-equipment area 1-equipment 1-C phase”. In another embodiment, the specified keyword may be “ID1”. Preferably, when the selected object information includes the part information, the specified keyword includes the part information.

In addition, the information related to the selected object information may be recorded to an information document or index document associated with the thermal image picture document. The control unit 11 may generate the information document or the index document. In addition, a document name of the thermal image picture document may be generated according to the object information selected by the selecting unit. Preferably, the recording unit includes a document name generating unit for generating a document name of a thermal image picture document. The generated document name of the thermal image picture document includes the information related to the object information selected by the selecting unit. For example, the generated document name may be “equipment area 1 equipment 1 C phase.jpg”. Further, the photographing time “20130207” may be combined to generate the document name, such as “substation 1 equipment area 1 equipment 1C phase-20130207.jpg”. When the object information includes a plurality of attributes, the document name may be generated according to the specified attribute information, such as “substation 1-equipment area1-equipment 1-C phase.jpg”. When the object information includes ID, the document name may be generated according to the ID information, such as “ID1.jpg”. The associated record is to record the information needed by the subsequent matching processing. The document name includes the object information, facilitating the examination of users and allowing the object information in the document name to be read during matching processing.

The embodiment of this invention is not limited to a portable thermal image photographing device, and may be applied to different kinds of online thermal image photographing devices. The function of photographing to acquire the thermal imaging data is not necessary in the invention. This invention may also be applied to a thermal image processing device receiving the thermal imaging data from outside and processing the thermal imaging data. The thermal image processing device may be a computer, a personal digital assistant, or a display matched with a thermal image photographing device with a photographing function.

### Other Embodiments

In one embodiment a thermal image arranging system includes the thermal image arranging device 1 in the first embodiment and the thermal imaging device 13 in the second embodiment.

In the invention, the program recorded on the storage device may be executed to perform by the computer (such as a CPU or a MPU) of the system or equipment with the function in the above embodiment, and the computer of the system or equipment may read and execute the program recorded on the storage device to perform the function in the above embodiment. To achieve the objective, the program acquired from the network or a record medium (such as a computer readable medium) as a storage device may be provided for the computer.

This invention provides a computer program, and digital signals composed by the computer program are recorded on a computer readable storage medium, such as a hard disk or a memory. The program is executed to perform the following steps:

an acquiring step for acquiring object information corresponding to a thermal imaging frame;

a comparing step for matching the object information based on object data information stored in a storage medium;

a recording step for recording the thermal imaging frame, corresponding to the object information matching the object data information, and/or the data acquired after specified processing for the thermal imaging frame, with the object data information.

Although the function block in the figures may be realized via hardware, software, or a combination thereof, the function block may be not necessary to be realized in one-by-one mode. For example, one software or hardware unit may be used for realizing multiple function blocks, or multiple software or hardware units may be used for realizing one function block. In addition, the processing and control functions of parts or whole in the embodiments may be realized via a special-use circuit, a general processor, or a programmable FPGA.

In addition, this embodiment is not limited to the batch arrangement of the thermal imaging frame, and may be suitable for the batch arrangement of the image data acquired by other optical imaging device such as a visible-light imaging device or ultraviolet imaging device.

In addition, in the embodiment, the electric power industry as the scene is taken for example, and different fields of the infrared detection are also applied. The object information and object data information in the above embodiments is just examples, according to different applications, the object information and the object data information may be different.

The above description is just detailed embodiments of the invention, and different examples and description does not limit the substantive contents of the invention. After reading the description, persons having ordinary skill in the art may make various modifications and changes without departing from the scope and spirit of the invention.

What is claimed is:

1. A thermal image arranging device, wherein the thermal image arranging device comprises:
an acquiring unit for acquiring object information;
a comparing unit for matching the object information based on object data information stored in a storage medium;
a recording unit for recording a thermal imaging frame that corresponds to the object information matching the specified object data information, and/or data acquired after specified processing for the thermal imaging frame, with the specified object data information.

2. The thermal image arranging device according to claim 1, wherein the acquiring unit comprises a selecting unit for selecting the thermal imaging frame, and the acquiring unit is used for acquiring the object information associated with the thermal imaging frame by analysis.

3. The thermal image arranging device according to claim 1, wherein the acquiring unit is used for analyzing a specified keyword in the object information associated with the thermal imaging frame, and the comparing unit is used for matching the specified keyword based on the object data information stored in the storage medium.

4. The thermal image arranging device according to claim 1, wherein the thermal image arranging device further comprises a first storage unit, and the recording unit is used for recording the thermal imaging frame and/or data acquired after specified processing for the thermal imaging frame with the corresponding object data information on the first storage unit.

5. The thermal image arranging device according to claim 1, wherein the thermal image arranging device further comprises a second storage unit, and the recording unit is used for recording unmatched thermal imaging frames and/or data acquired after specified processing for the unmatched thermal imaging frames on the second storage unit.

6. The thermal image arranging device according to claim 1, wherein the thermal image arranging device further comprises an analyzing unit for analyzing the thermal imaging frame, wherein the object information associated with the thermal imaging frame matches the object data information, and the recording unit is used for recording the thermal imaging frame and an analysis result of the thermal imaging frame with the object data information.

7. The thermal image arranging device according to claim 1, wherein the comparing unit is used for matching the object information based on the object data information in a database.

8. The thermal image arranging device according to claim 7, wherein the acquiring unit comprises a selecting unit for selecting the thermal imaging frame, and the acquiring unit is used for acquiring the object information associated with the thermal imaging frame by analysis.

9. The thermal image arranging device according to claim 7, wherein the acquiring unit is used for analyzing a specified keyword in the object information associated with the thermal imaging frame, and the comparing unit is used for matching the specified keyword based on the object data information in the database.

10. The thermal image arranging device according to claim 7, wherein the thermal image arranging device further comprises a first storage unit, and the recording unit is used for recording the thermal imaging frame and/or data acquired after specified processing for the thermal imaging frame with the corresponding object data information on the first storage unit.

11. The thermal image arranging device according to claim 7, wherein the thermal image arranging device further comprises a second storage unit, and the recording unit is used for recording unmatched thermal imaging frames and/or data acquired after specified processing for the unmatched thermal imaging frames on the second storage unit.

12. The thermal image arranging device according to claim 7, wherein the thermal image arranging device further comprises an analyzing unit for analyzing the thermal imaging frame, wherein the object information associated with the thermal imaging frame matches the object data information; and the recording unit is used for recording the thermal imaging frame and an analysis result of the thermal imaging frame with the object data information.

13. A recording device, wherein the recording device comprises:
a photographing unit for photographing to acquire thermal imaging data;
an object information selecting unit for selecting object information from the object information stored in a storage medium;
a thermal image recording unit for recording a specified keyword in the object information selected by the object information selecting unit with a thermal imaging frame, wherein the thermal imaging frame at least comprises the thermal imaging data acquired by the photographing unit or data acquired after specified processing for the thermal imaging data.

14. A processing system, wherein the processing system comprises a recording device and a thermal image arranging device, the recording device comprises:
a photographing unit for photographing to acquire thermal imaging data;
an object information selecting unit for selecting object information from the object information stored in a storage medium; and
a thermal image recording unit for recording a specified keyword in the object information selected by the object information selecting unit with a thermal imaging frame, the thermal imaging frame at least comprises the thermal imaging data acquired by the photographing unit or data acquired after specified processing for the thermal imaging data;
the thermal image arranging device comprises:
an acquiring unit for acquiring the object information;
a comparing unit for matching the object information based on object data information stored in a storage medium; and
a recording unit for recording the thermal imaging frame that corresponds to the object information matching the specified object data information, and/or data acquired after specified processing for the thermal imaging frame, with the object data information;
wherein the object information acquired by the acquiring unit in the thermal image arranging device is the object information recorded by the thermal image recording unit in the recording device.

15. The processing system according to claim 14, wherein the acquiring unit comprises a selecting unit for selecting the thermal imaging frame, and the acquiring unit is used for acquiring the object information associated with the thermal imaging frame by analysis.

16. The processing system according to claim 14, wherein the comparing unit is used for matching the object information based on the object data information in a database.

17. The processing system according to claim 14, wherein the acquiring unit is used for analyzing a specified keyword in the object information associated with the thermal imaging frame, and the comparing unit is used for matching the specified keyword based on the object data information in a database.

18. A thermal image arranging method, wherein the thermal image arranging method comprises:
an acquiring step for acquiring object information;
a comparing step for matching the object information based on object data information stored in a storage medium;
a recording step for recording a thermal imaging frame that corresponds to the object information matching the object data information, and/or data acquired after specified processing for the thermal imaging frame, with the object data information.

19. The thermal image arranging method according to claim 18, wherein the comparing step is used for matching the object information based on the object data information in a database.

20. The thermal image arranging method according to claim 18, wherein the acquiring step comprises a selecting step for selecting the thermal imaging frame, and the acquiring step is used for acquiring the object information associated with the thermal imaging frame by analysis.

21. The thermal image arranging method according to claim 18, wherein the acquiring step is used for analyzing a specified keyword in the object information associated with the thermal imaging frame, and the comparing step is used for matching the specified keyword based on the object data information in a database.

22. The thermal image arranging method according to claim 18, wherein the recording step is used for recording the thermal imaging frame and/or data acquired after specified processing for the thermal imaging frame with the corresponding object data information on a first storage unit, and is used for recording unmatched thermal imaging frames and/or data acquired after specified processing for the unmatched thermal imaging frames on a second storage unit.

23. A recording method, wherein the recording method comprises:
a photographing step for photographing to acquire thermal imaging data;
an object information selecting step for selecting object information from the object information stored in a storage medium;
a thermal image recording step for recording a specified keyword in the object information selected in the object information selecting step with a thermal imaging frame, wherein the thermal imaging frame at least comprises the thermal imaging data acquired in the photographing step or data acquired after specified processing for the thermal imaging data.

24. A processing method, wherein the processing method comprises:
a photographing step for photographing to acquire thermal imaging data;
an object information selecting step for selecting object information from the object information stored in a storage medium;
a thermal image recording step for recording a specified keyword in the object information selected in the object information selecting step with a thermal imaging frame, the thermal imaging frame at least comprises the thermal imaging data acquired in the photographing step and/or data acquired after specified processing for the thermal imaging data;
an acquiring step for acquiring the object information relatedly recorded in the thermal image recording step;
a comparing step for matching the object information based on object data information stored in a storage medium;
a recording step for recording a thermal imaging frame that corresponds to the object information matching the object data information, and/or data acquired after specified processing for the thermal imaging frame, with the object data information.

25. The processing method according to claim 24, wherein the comparing step is used for matching the object information based on the object data information in a database.
